(19) United States
(12) Patent Application Publication
(10) Pub. No.: US 2024/0204238 A1
(43) Pub. Date: Jun. 20, 2024

(54) POWER STORAGE CELL MANUFACTURING METHOD AND POWER STORAGE CELL

(71) Applicant: TOYOTA JIDOSHA KABUSHIKI KAISHA, Toyota-shi (JP)

(72) Inventor: Kenichi KAKISHITA, Nagoya-shi (JP)

(73) Assignee: TOYOTA JIDOSHA KABUSHIKI KAISHA, Toyota-shi (JP)

(21) Appl. No.: 18/537,271

(22) Filed: Dec. 12, 2023

(30) Foreign Application Priority Data
Dec. 20, 2022 (JP) 2022-203433

(51) Int. Cl. H01M 10/04; H01M 50/538

(52) U.S. Cl. CPC H01M 10/0431; H01M 50/538

(57) ABSTRACT

A method of manufacturing a power storage cell includes: a preparing step of preparing an electrode sheet including a current collecting foil and an active material layer; a cutting step of forming a plurality of cuts in the current collecting foil; and a winding step of winding the electrode sheet around a winding core. The current collecting foil includes an end region that is not provided with the active material layer. In the cutting step, the plurality of cuts are formed in the end region such that a coupling portion is formed in the end region. In the winding step, the electrode sheet is wound around the winding core to cause the coupling portion to be fractured along the cuts and the fracturing of the coupling portion forms connecting pieces that are leaned toward the winding core.

### CROSS REFERENCE TO RELATED APPLICATIONS

This nonprovisional application is based on Japanese Patent Application No. 2022-203433 filed on Dec. 20, 2022 with the Japan Patent Office, the entire contents of which are hereby incorporated by reference.

### BACKGROUND

### Field

The present disclosure relates to a method of manufacturing a power storage cell and to a power storage cell.

### Description of the Background Art

Japanese Patent No. 4401634 discloses a rechargeable battery including an electrode plate group that includes a positive electrode plate, a negative electrode plate, and a separator, and a battery case that houses the electrode plate group. A plurality of cuts are formed in a strip-shaped current collecting portion of each electrode plate. The strip-shaped current collecting portion has a plurality of connecting pieces each formed between the cuts. These electrode plates are spirally wound with the separator interposed therebetween to form the group of electrode plates.

### SUMMARY

In the case of the method of manufacturing a power storage cell described in Japanese Patent No. 4401634, when each electrode plate is spirally wound with the separator interposed, the connecting piece may lean in a direction away from the winding core (outward in the radial direction of the winding core).

It is an object of the present disclosure to provide a method of manufacturing a power storage cell as well as a power storage cell that enable prevention of the connecting piece from leaning in the direction away from the winding core during winding.

A method of manufacturing a power storage cell according to one aspect of the present disclosure includes: a preparing step of preparing an electrode sheet including a current collecting foil having a shape elongated in one direction, and an active material layer provided on a surface of the current collecting foil; a cutting step of forming a plurality of cuts in the current collecting foil that are separated from each other in the one direction; and a winding step of winding the electrode sheet around a winding core, wherein the current collecting foil of the electrode sheet prepared in the preparing step includes an end region that is not provided with the active material layer, the end region includes an edge portion in an orthogonal direction orthogonal to both the one direction and a thickness direction of the current collecting foil, and the end region has a shape continuous in the one direction; in the cutting step, the plurality of cuts are formed in the end region such that a coupling portion is formed in the end region, the coupling portion including the edge portion in the orthogonal direction and extending in the one direction; and in the winding step, the electrode sheet is wound around the winding core to cause the coupling portion to be fractured along the cuts and the fracturing of the coupling portion forms connecting pieces in the end region, and the connecting pieces are leaned toward the winding core.

A power storage cell according to one aspect of the present disclosure includes: an electrode assembly including a positive electrode sheet, a negative electrode sheet, and a separator, and constructed as a wound body in which the positive electrode sheet and the negative electrode sheet are wound with the separator interposed between the positive electrode sheet and the negative electrode sheet, wherein each of the positive electrode sheet and the negative electrode sheet includes: a current collecting foil; and an active material layer provided on a surface of the current collecting foil, the current collecting foil includes: a main region provided with the active material layer and arranged to overlap with itself in a radial direction of the wound body; and an end region formed outside the main region in an axial direction of the wound body, the end region being not provided with the active material layer, the end region includes a plurality of connecting pieces that are separated from each other in a circumferential direction of the wound body and leaned inward in the radial direction of the wound body, and each of the connecting pieces includes: a cut end face formed by a cut in the current collecting foil; and a fracture end face formed inward of the cut end face in the radial direction and formed by a fracture in the current collecting foil.

These and other objects, features, aspects and advantages of the disclosure will become apparent from the following detailed description of the disclosure, which is understood in conjunction with the accompanying drawings.

### BRIEF DESCRIPTION OF THE DRAWINGS

FIG. 1 is a partial cross-sectional view schematically showing a power storage cell according to an embodiment of the present disclosure.

FIG. 2 is a plan view schematically showing a positive electrode sheet before winding.

FIG. 3 is a perspective view schematically showing a winding step in which an electrode sheet is wound around a winding core.

FIG. 4 is a view schematically showing a modified example of the cut.

FIG. 5 is a view schematically showing a modified example of the cut.

FIG. 6 is a view schematically showing a modified example of the coupling portion and the cut.

FIG. 7 is a view schematically showing a modified example of the coupling portion and the cut.

### DESCRIPTION OF THE PREFERRED EMBODIMENTS

Embodiments of the present disclosure will be described with reference to the drawings. In the drawings referred to below, the same or corresponding members are denoted by the same reference numerals.

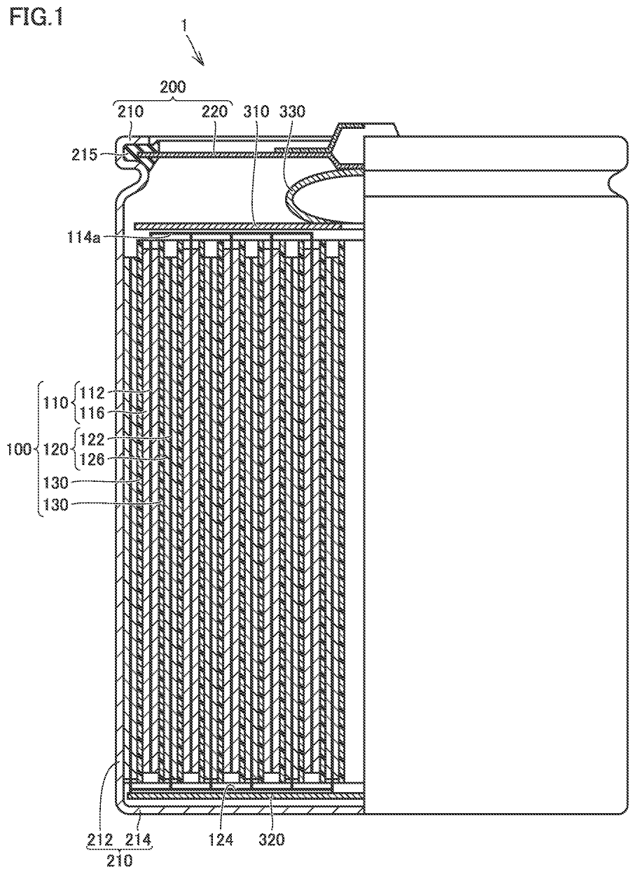

FIG. 1 is a partial cross-sectional view schematically showing a power storage cell according to an embodiment of the present disclosure. The power storage cell 1 is preferably mounted on a vehicle.

As shown in FIG. 1, the power storage cell 1 includes an electrode assembly 100, a cell case 200, a positive electrode current collector plate 310, a negative electrode current collector plate 320, and a coupling lead 330.

The electrode assembly 100 includes a positive electrode sheet 110, a negative electrode sheet 120, and a separator 130. The electrode assembly 100 is a wound body formed by winding a positive electrode sheet 110 and a negative electrode sheet 120 with a separator 130 interposed therebetween.

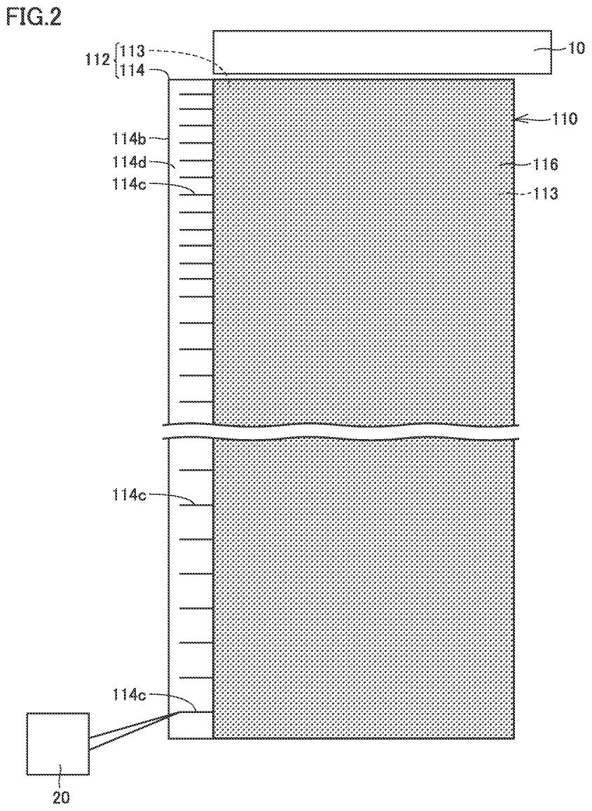

FIG. 2 is a plan view schematically showing a positive electrode sheet before winding. As shown in FIGS. 1 and 2, the positive electrode sheet 110 includes a positive electrode current collecting foil 112 and a positive electrode active material layer 116.

The positive electrode current collecting foil 112 is made of a metal such as aluminum. The positive electrode current collecting foil 112 has a main region 113 and an end region 114.

The main region 113 is a region in which the positive electrode active material layer 116 is provided in the positive electrode current collecting foil 112. The main region 113 is arranged to overlap with itself in the radial direction of the wound body (electrode assembly 100).

The end region 114 is a region in which the positive electrode active material layer 116 is not provided in the positive electrode current collecting foil 112. As shown in FIG. 1, the end region 114 is formed outside (upper side in FIG. 1) the main region 113 in the axial direction (vertical direction in FIG. 1) of the electrode assembly 100.

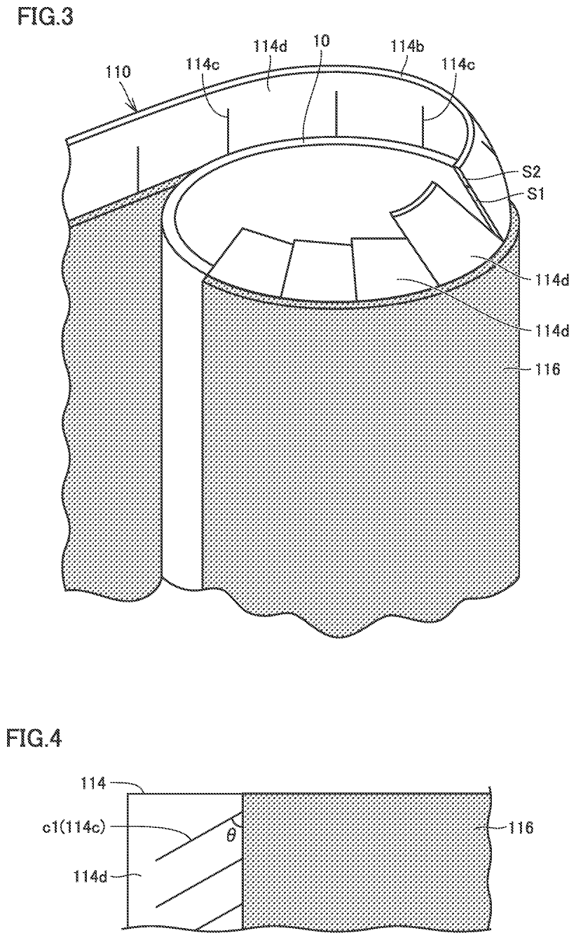

The end region 114 has a plurality of connecting pieces 114a (see FIG. 3) separated from each other in the circumferential direction of the electrode assembly 100. Each connecting piece 114a leans inward in the radial direction. The upper surface of each connecting piece 114a forms a substantially flat surface.

As shown in FIG. 3, each connecting piece 114a has a cut end face S1 and a fracture end face S2. The cut end face S1 is an end face formed by a cut in the end region 114 of the positive electrode current collecting foil 112. The fracture end face S2 is formed inside the cut end face S1 in the radial direction. The fracture end face S2 is an end face formed by a fracture in the end region 114 of the positive electrode current collecting foil 112.

The negative electrode sheet 120 includes a negative electrode current collecting foil 122 made of a metal such as copper, and a negative electrode active material layer 126 provided on the surface of the negative electrode current collecting foil 122.

The structure of the negative electrode current collecting foil 122 is substantially the same as the structure of the positive electrode current collecting foil 112. Therefore, the description of the negative electrode current collecting foil 122 is simplified. That is, the negative electrode current collecting foil 122 has a main region 123 in which the negative electrode active material layer 126 is provided, and an end region 124 formed on the outside (lower side in FIG. 1) of the main region 123 in the axial direction. The end region 124 has a plurality of connecting pieces that lean inward in the radial direction, and each connecting piece has a cut end face and a fracture end face.

The separator 130 is disposed between the positive electrode sheet 110 and the negative electrode sheet 120. More specifically, the separator 130 is disposed only between the main region 113 of the positive electrode sheet 110 and the main region 123 of the negative electrode sheet 120 adjacent to each other in the radial direction. The separator 130 is made of an insulating material and allows penetration of ions.

The cell case 200 houses the electrode assembly 100. The cell case 200 also contains an electrolyte solution (not shown). The cell case 200 is sealed. The cell case 200 includes a case body 210 and a lid 220.

The case body 210 opens upward. The case body 210 is made of metal such as aluminum. The case body 210 includes a bottom wall 212 and a peripheral wall 214. The bottom wall 212 is formed in a disc shape. The peripheral wall 214 rises from the edge of the bottom wall 212 and is formed in a cylindrical shape.

The lid 220 closes the opening of the case body 210. The lid 220 is connected to the case body 210 via a sealing member 215.

The positive electrode current collector plate 310 is disposed above the electrode assembly 100. The positive electrode current collector plate 310 is connected to the upper surface of each connecting piece 114a of the positive electrode current collecting foil 112 by welding or the like.

The negative electrode current collector plate 320 is disposed below the electrode assembly 100. The negative electrode current collector plate 320 is connected to an upper surface of each connecting piece of the negative electrode current collecting foil 122 by welding or the like.

The coupling lead 330 connects the positive electrode current collector plate 310 and the lid 220.

Next, a method of manufacturing the power storage cell 1 will be described with reference to FIGS. 2 and 3. This manufacturing method includes a preparing step, a cutting step, and a winding step. Hereinafter, the positive electrode sheet 110 and the negative electrode sheet 120 are referred to as “electrode sheet”, the positive electrode current collecting foil 112 and the negative electrode current collecting foil 122 are referred to as “current collecting foil”, and the positive electrode active material layer 116 and the negative electrode active material layer 126 are referred to as “active material layer”. In FIGS. 2 and 3, the positive electrode sheet 110 is shown as an example. In FIG. 3, illustration of the separator 130 is omitted.

In the preparing step, an electrode sheet is prepared. Specifically, in the preparing step, an electrode sheet including a current collecting foil having a shape elongated in one direction (the vertical direction in FIG. 2) and an active material layer provided on the surface of the current collecting foil is prepared. The respective current collecting foils of the electrode sheets 110 and 120 prepared in the preparing step include main regions 113 and 123 and end regions 114 and 124. The main regions 113 and 123 are formed, for example, by providing an active material layer on a current collecting foil conveyed by a conveying roll. The end regions 114 and 124 are adjacent to the main regions 113 and 123 in the orthogonal direction (the left-right direction in FIG. 2) orthogonal to both the one direction and the thickness direction of the current collecting foil. The lengths of the main regions 113 and 123 in the orthogonal direction are set to 80 mm, for example, and the lengths of the end regions 114 and 124 in the orthogonal direction are set to 5 mm, for example. The end regions 114 and 124 are in a shape continuous in one direction. The end regions 114, 124 include an edge portion 114b in orthogonal direction.

In the cutting step, a plurality of cuts 114c (see FIG. 2) spaced apart from each other in one direction are formed in the current collecting foil. Specifically, in the cutting step, a plurality of cuts 114c, each of which is spaced apart from the edge portion 114b in the orthogonal direction and separated from each other in one direction, are formed. Thereby, in the end regions 114 and 124, a coupling portion 114d including the edge portion 114b in the orthogonal direction and extending along one direction is formed. In other words, in the cutting step, a plurality of cuts 114c are formed in the end regions 114 and 124 so that the coupling portions 114d are formed in the end regions 114 and 124. More specifically, in the cutting step, a plurality of cuts 114c are formed in the end regions 114 and 124 so that a coupling portion 114d continuous from one end to the other end of the end regions 114 and 124 in one direction is formed. Each cut 114c may be formed parallel to the orthogonal direction. For example, each cut 114c may be formed by laser radiation from the laser irradiation unit 20 as shown in FIG. 2, or may be formed by a blade. FIG. 2 shows the positive electrode sheet 110 of the electrode sheet after the cutting step.

In the winding step, the electrode sheet and the separator 130 are wound around the winding core 10. As shown in FIGS. 2 and 3, the electrode sheet is wound around the winding core 10 at a position where the active material layer overlaps the winding core 10. The separator 130 is disposed at a position overlapping only the main regions 113 and 123.

When the electrode sheet is wound around the winding core 10, surface pressure toward the winding core 10 acts on the end regions 114 and 124. When the surface pressure is P [MPa], the tension of the electrode sheet is T [N], the length (width) of the end regions 114 and 124 in the orthogonal direction is W [mm], and the winding radius is R [mm], the surface pressure P is represented by the following equation.

P=T/(WR)

For this reason, in the winding step, as shown in FIG. 3, by winding the electrode sheet and the separator 130 around the winding core 10, the coupling portion 114d is fractured along the cuts 114c, and the connecting pieces 114a formed in the end regions 114 and 124 are leaned toward the winding core 10 by the fracturing of the coupling portion 114d. More specifically, when the surface pressure toward the winding core 10 is applied to the end regions 114 and 124 at the time of winding of the electrode sheet, the inner (upper side in FIG. 2) portion of the pair of portions of the end regions 114 and 124 sandwiching the cut 114c in the winding direction begins to be leaned toward the winding core 10 first, so that a shearing force acts on the portion of the pair of portions outside the cut 114c in the orthogonal direction, i.e., the coupling portion 114d. For this reason, the coupling portion 114d is fractured such that the cut 114c reaches the edge portion 114b of the end region 114, and the connecting piece 114a formed by the fracturing is leaned toward the winding core 10 by the surface pressure. Each of the connecting pieces 114a formed in this manner has a cut end face S1 formed by cutting in the cutting step and a fracture end face S2 formed by fracturing in the winding step.

As described above, in the manufacturing method of the power storage cell 1 according to the present embodiment, when the electrode sheet is wound around the winding core 10 in the winding step, the end regions 114 and 124 have the coupling portions 114d, so that the surface pressure toward the winding core 10 acts on the end regions 114 and 124 when the electrode sheet is wound. Then, the coupling portion 114d is fractured by the surface pressure, and the connecting piece 114a formed by the fracturing is leaned toward the winding core 10. Therefore, the connecting piece 114a is prevented from being leaned in the direction away from the winding core 10 (outward in the radial direction) during winding.

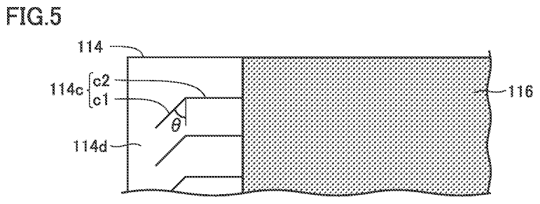

In the above embodiment, as shown in FIGS. 4 and 5, in the cutting step, the cut 114c including the inclined portion c1 may be formed so as to gradually incline toward the outer side (the left side in FIG. 4) in the orthogonal direction, toward the outer side (the lower side in FIG. 4) in the winding direction. In the example shown in FIG. 4, the cut 114c includes only the inclined portion c1. In the example shown in FIG. 5, the cut 114c includes an inclined portion c1 and an inner portion c2 formed inside the inclined portion c1 in the orthogonal direction. The inner portion c2 is formed parallel to the orthogonal direction. The angle θ formed between the one direction and the inclined portion c1 is preferably set to not less than 10 degrees and not more than 80 degrees, and more preferably set to not less than 30 degrees and not more than 75 degrees.

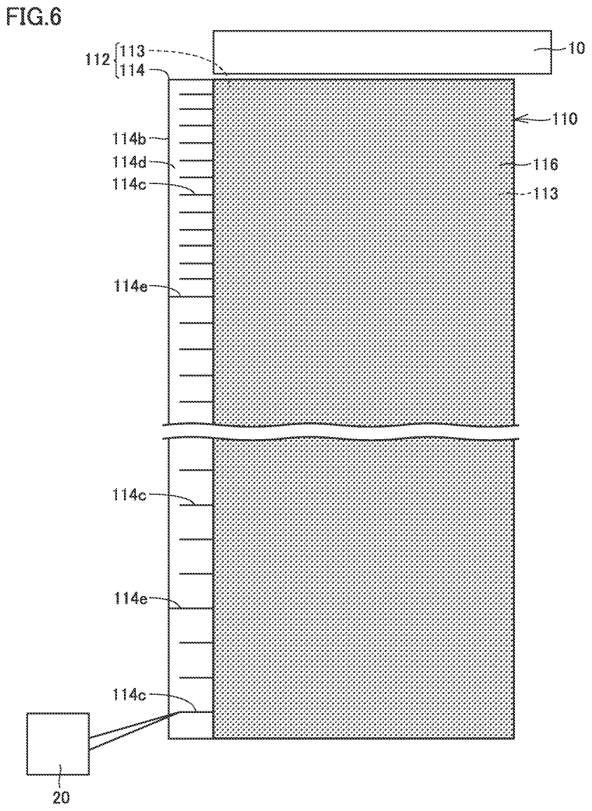

Also, as shown in FIG. 6, the plurality of cuts 114c may include cutting cuts 114e extending to edge portion 114b. The cutting cut 114e divides the coupling portion 114d. The cutting cuts 114e are formed at intervals equal to or longer than the length of one circumference of the electrode sheet wound around the winding core 10 (the product of the diameter of the electrode sheet and the circumferential ratio). In this example, although the coupling portion 114d is interrupted by the cutting cut 114e, since the length of the coupling portion 114d in one direction is equal to or greater than the length of one circumference of the electrode sheet wound around the winding core 10, the surface pressure effectively acts on the end regions 114 and 124 in the winding step.

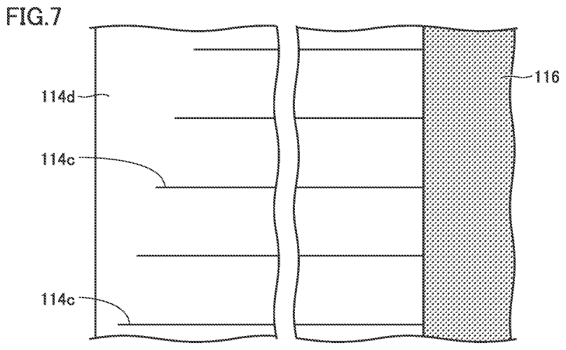

Further, as shown in FIG. 7, in the cutting step, the plurality of cuts 114c may be formed such that the length of the coupling portion 114d in the orthogonal direction gradually decreases toward the outer side (the lower side in FIG. 7) in the winding direction.

It will be appreciated by those skilled in the art that the exemplary embodiments described above are specific examples of the following aspects.

### [Aspect 1]

A method of manufacturing a power storage cell includes:
a preparing step of preparing an electrode sheet including
   a current collecting foil having a shape elongated in one direction, and
   an active material layer provided on a surface of the current collecting foil;
a cutting step of forming a plurality of cuts in the current collecting foil that are separated from each other in the one direction; and
a winding step of winding the electrode sheet around a winding core, wherein
the current collecting foil of the electrode sheet prepared in the preparing step includes an end region that is not provided with the active material layer, the end region includes an edge portion in an orthogonal direction orthogonal to both the one direction and a thickness direction of the current collecting foil, and the end region has a shape continuous in the one direction,
in the cutting step, the plurality of cuts are formed in the end region such that a coupling portion is formed in the end region, the coupling portion including the edge portion in the orthogonal direction and extending in the one direction, and
in the winding step, the electrode sheet is wound around the winding core to cause the coupling portion to be fractured along the cuts and the fracturing of the coupling portion forms connecting pieces in the end region, and the connecting pieces are leaned toward the winding core.

According to this method of manufacturing a power storage cell, when the electrode sheet is wound around the winding core in the winding step, since the end region has the coupling portion, the surface pressure toward the winding core acts on the end region during the winding of the electrode sheet. Then, the inner one, in the winding direction, of a pair of portions of the end region that sandwich the cut first begins to be leaned toward the winding core, so that a shearing force acts on an outer portion of the pair of portions that is located outward of the cuts in the orthogonal direction, i.e., acts on the coupling portion. Therefore, the coupling portion is fractured such that the cut reaches the edge portion of the end region, and the resultant connecting pieces formed by the fracturing are leaned toward the winding core by the surface pressure. Thus, the connecting piece is prevented from being leaned outward during winding.

### [Aspect 2]

The method of manufacturing a power storage cell according to Aspect 1,
wherein in the cutting step, the cuts are each formed to include an inclined portion that inclines toward an outer side in the orthogonal direction, gradually toward an outer side in the winding direction.

In this aspect, the air resistance acting on the connecting piece in the winding step is reduced. Accordingly, even when the winding core is rotated at a high speed in the winding step, each connecting piece is effectively leaned toward the winding core.

### [Aspect 3]

The method of manufacturing a power storage cell according to Aspect 1 or 2, wherein in the cutting step, the plurality of cuts are formed in the end region such that the coupling portion continuous from one end to the other end of the end region in the one direction is formed.

In this aspect, the surface pressure acts stably on the coupling portion in the winding step, and therefore, each connecting piece is leaned stably toward the winding core.

### [Aspect 4]

The method of manufacturing a power storage cell according to any one of Aspects 1 to 3, wherein in the cutting step, the plurality of cuts are formed such that a length, in the orthogonal direction, of the coupling portion decreases gradually toward an outer side in the winding direction.

In this aspect, the coupling portion is fractured stably in the winding step, also in the outer portion of the end region in the winding direction.

### [Aspect 5]

A power storage cell including:
an electrode assembly including a positive electrode sheet, a negative electrode sheet, and a separator, and constructed as a wound body in which the positive electrode sheet and the negative electrode sheet are wound with the separator interposed between the positive electrode sheet and the negative electrode sheet, wherein
each of the positive electrode sheet and the negative electrode sheet includes:
   a current collecting foil; and
   an active material layer provided on a surface of the current collecting foil
the current collecting foil includes:
   a main region provided with the active material layer and arranged to overlap with itself in a radial direction of the wound body; and
   an end region formed outside the main region in an axial direction of the wound body, the end region being not provided with the active material layer,
the end region includes a plurality of connecting pieces that are separated from each other in a circumferential direction of the wound body and leaned inward in the radial direction, and
each of the connecting pieces includes:
   a cut end face formed by a cut in the current collecting foil; and
   a fracture end face formed inward of the cut end face in the radial direction and formed by a fracture in the current collecting foil.

In this power storage cell, since each of the connecting pieces has a fracture end face, an increase in contact resistance at a welded portion between each of the connecting pieces and the current collector plate is suppressed as compared with the case where each of the connecting pieces is formed only by the cut end face. For example, in the case where the connecting pieces are formed only by cutting with a laser, a melt may adhere to an end of the cut surface, and in the case where the connecting pieces are formed only by cutting with a blade, the contact resistance between each of the connecting pieces and the current collector plate may increase because there may be a flash generated at an end of the cut surface. In contrast, since the above-mentioned melt or flash is not generated in the fracture end face, an increase in contact resistance is suppressed.

### [Aspect 6]

An electrode sheet that is wound together with a separator to form an electrode assembly constructed as a wound body, the electrode sheet including:
a current collecting foil having a shape elongated in one direction; and
an active material layer provided on a surface of the current collecting foil, wherein
the current collecting foil includes:
   a main region provided with the active material layer; and
   an end region including an edge portion in an orthogonal direction orthogonal to both the one direction and a thickness direction of the current collecting foil, the end region is continuous in the one direction, and the end region is not provided with the active material layer, and
a plurality of cuts are formed in the end region that are each separated from the edge portion in the orthogonal direction, and that are separated from each other in the one direction.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A method of manufacturing a power storage cell, the method comprising:
a preparing step of preparing an electrode sheet including
a current collecting foil having a shape elongated in one direction, and
an active material layer provided on a surface of the current collecting foil;
a cutting step of forming a plurality of cuts in the current collecting foil that are separated from each other in the one direction; and
a winding step of winding the electrode sheet around a winding core, wherein
the current collecting foil of the electrode sheet prepared in the preparing step includes an end region that is not provided with the active material layer, the end region includes an edge portion in an orthogonal direction orthogonal to both the one direction and a thickness direction of the current collecting foil, and the end region has a shape continuous in the one direction,
in the cutting step, the plurality of cuts are formed in the end region such that a coupling portion is formed in the end region, the coupling portion including the edge portion in the orthogonal direction and extending in the one direction, and
in the winding step, the electrode sheet is wound around the winding core to cause the coupling portion to be fractured along the cuts and the fracturing of the coupling portion forms connecting pieces in the end region, and the connecting pieces are leaned toward the winding core.

2. The method of manufacturing a power storage cell according to claim 1, wherein in the cutting step, the cuts are each formed to include an inclined portion that inclines toward an outer side in the orthogonal direction, gradually toward an outer side in the winding direction.

3. The method of manufacturing a power storage cell according to claim 1, wherein in the cutting step, the plurality of cuts are formed in the end region such that the coupling portion continuous from one end to the other end of the end region in the one direction is formed.

4. The method of manufacturing a power storage cell according to claim 1, wherein in the cutting step, the plurality of cuts are formed such that a length, in the orthogonal direction, of the coupling portion decreases gradually toward an outer side in the winding direction.

5. A power storage cell comprising:
an electrode assembly including a positive electrode sheet, a negative electrode sheet, and a separator, and constructed as a wound body in which the positive electrode sheet and the negative electrode sheet are wound with the separator interposed between the positive electrode sheet and the negative electrode sheet, wherein
each of the positive electrode sheet and the negative electrode sheet includes:
a current collecting foil; and
an active material layer provided on a surface of the current collecting foil,
the current collecting foil includes:
a main region provided with the active material layer and arranged to overlap with itself in a radial direction of the wound body; and
an end region formed outside the main region in an axial direction of the wound body, the end region being not provided with the active material layer,
the end region includes a plurality of connecting pieces that are separated from each other in a circumferential direction of the wound body and leaned inward in the radial direction, and
each of the connecting pieces includes:
a cut end face formed by a cut in the current collecting foil; and
a fracture end face formed inward of the cut end face in the radial direction and formed by a fracture in the current collecting foil.
